(19) United States
(12) Patent Application Publication
(10) Pub. No.: US 2013/0232837 A1
(43) Pub. Date: Sep. 12, 2013

(54) OPEN HOUSE SIGN WITH INTERCHANGEABLE LETTERS

(71) Applicant: Irene Guanill-Elukowich, Bronx, NY (US)

(72) Inventor: Irene Guanill-Elukowich, Bronx, NY (US)

(21) Appl. No.: 13/537,044

(22) Filed: Jun. 28, 2012

Related U.S. Application Data
(60) Provisional application No. 61/609,174, filed on Mar. 9, 2012.

(51) Int. Cl. G09F 7/08

(52) U.S. Cl. 40/618

(57) ABSTRACT

An open house sign has two slats to feed letters of an open house address, date, time, directional arrow, and the like. The open house sign allows potential clients to clearly understand by reading the clear lettering, location and time on the open house as clearly as they are reading the standard sign. The open house sign also allows real estate professionals a clear way to update an open house sign's address, date and time without wasting paper while presenting a professional look to the public. These signs may also be used for garage sales.

### CROSS-REFERENCE TO RELATED APPLICATIONS

This application claims the benefit of priority of U.S. provisional patent application No. 61/609,174, filed Mar. 9, 2012, the contents of which are herein incorporated by reference.

### BACKGROUND OF THE INVENTION

The present invention relates to tools for Realtors and, more particularly, to a design of an open house sign with a slate to feed the letters of the open house address, date and time, along with a directional arrow.

Often, when a Realtor has an open house, they will put signs up at key intersections close to the designated location to help direct people to visit during the open house. Sometimes, the Realtor only puts an arrow on the sign, providing a general direction toward the open house. This arrow may not be clear to the general public. However, in a development with many residential streets, for example, several of these directional signs may be needed to prevent a driver from missing a turn and, thus, missing the open house. Moreover, with these directional only signs, no time is provided—therefore, the Realtor must put up the signs immediately before the open house and take them down immediately after.

Some conventional open house signs include a space to put in the address, date and time. These spaces are usually filled in by attaching paper to the sign, where the paper has the address, date and time of the open house filled in. Wind and rain may damage the paper. Also, these hand-written paper signs rely on the Realtor's handwriting to get the message to the potential buyers. While a Realtor may use a computer to print out the paper messages for the signs, this is a time consuming task and still does not solve the problem of having the information disposed of on a piece of attached paper.

As can be seen, there is a need for an improved sign that includes a method for interchanging data on the sign to provide a time effective, professional appearing and accurate sign that may be used for real estate open houses, for garage sales and the like.

### SUMMARY OF THE INVENTION

In one aspect of the present invention, an open house sign comprises at least two boarders attached parallel to each other on a front face of the open house sign; a slot in each of the boarders, the boarders disposed with an open end of the slots facing each other; and a plurality of letter cards adapted to be inserted into and retained by the slots of adjacent ones of the boarders. The design may also be attached to an existing Open House sign that is designed with the slates and utilizes the same size lettering.

In another aspect of the present invention, an open house sign comprises preprinted information on a front face of the open house sign, the preprinted information including Realtor contact information; at least two boarders attached parallel to each other on the front face of the open house sign; a slot in each of the boarders, the boarders disposed with an open end of the slots facing each other; and a plurality of weatherproof letter cards adapted to be inserted into and retained by the slots of adjacent ones of the boarders.

These and other features, aspects and advantages of the present invention will become better understood with reference to the following drawings, description and claims.

### BRIEF DESCRIPTION OF THE DRAWINGS

FIG. 1 is a front view of an open house sign according to an exemplary embodiment of the present invention;

FIG. 2 is a side view of the open house sign of FIG. 1;

FIG. 3 is a side view of a two-lined open house sign according to an exemplary embodiment of the present invention;

FIG. 4 is a front view of an open house sign adapted to accept an add-on customizable attachment according to an exemplary embodiment of the present invention;

FIG. 5 is a front view of the open house sign of FIG. 4, with the add-on customizable attachment attached thereto;

FIG. 6 is a front view of a directional sign having boarders to accept interchangeable letters, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an open house sign with a slate to feed letters of an open house address, date, time, directional arrow, and the like. The sign of the present invention allows potential clients to clearly understand by reading the clear lettering, location and time of the open house as clearly as they are reading the standard sign. The sign of the present invention also allows real estate professionals a clear way to update an open house sign's address without wasting paper while presenting a professional look to the public.

The open house sign of the present invention allows the user to interchange data without wasting time or paper, changing the method of display to be time effective, accurate, and professional in appearance. Conventional open house signs do not benefit the public or the time schedule of the Realtor. The time it takes to go to the office, create the address, fold the paper and then tape the paper to an open house sign will be replaced with slip and slide letters that are clear to read. Moreover, the open house sign of the present invention allows the potential clients to clearly understand by reading the clear lettering, location and time on the open house as clearly as they are reading the standard sign.

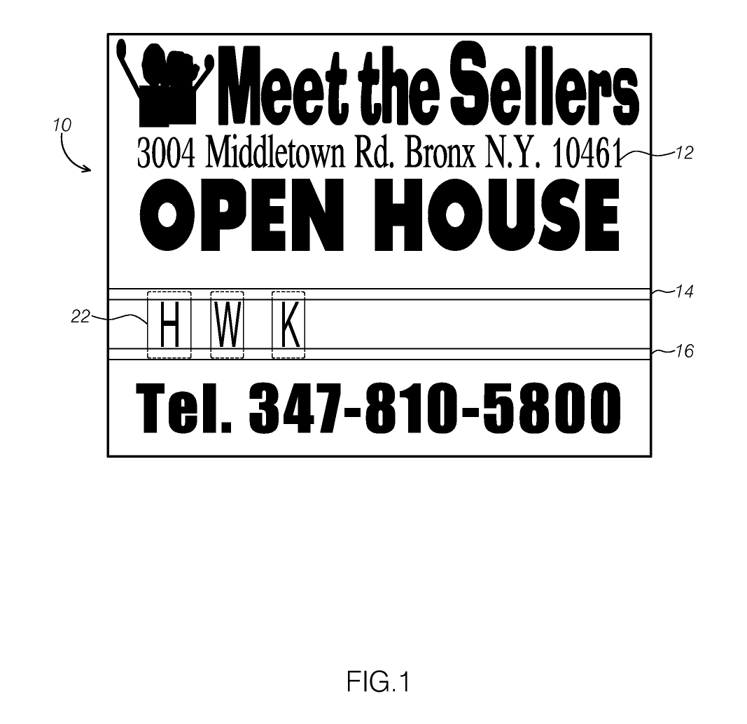

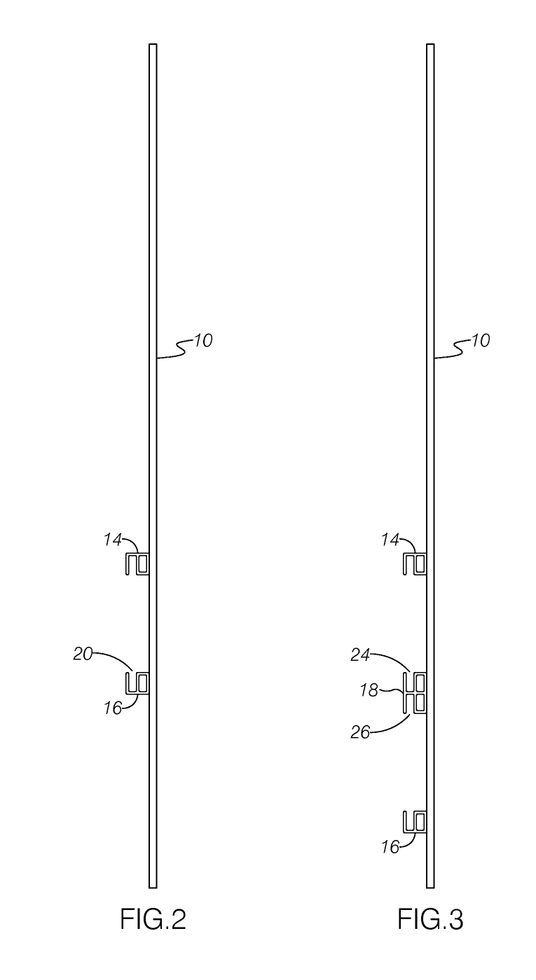

Referring to FIGS. 1 and 2, an open house sign 10 may include typical open house signage 12, such as the name, address and phone number of the Realtor, pre-printed on the sign. The open house sign 10 may further include an upper letter boarder 14 and a lower letter boarder 16. The boarders 14, 16 may be designed with a slot 20 for inserting letter cards 22 (letter cards 22 refers generically to not only letters, but also numbers, symbols, directional arrows and the like). The boarders 14, 16 may be designed as adhesive strips that the user may cut to the appropriate length and attach to their own sign. In some embodiments, the boarders 14, 16 may be pre-formed onto a sign, either by an adhesive, glue, plastic molding, or the like. The boarders 14, 16 may be made from various materials, such as plastic, metal, composite, or the like.

The slots 20 may be made in various sizes and angles. While the figures show the slots 20 slanted inward, other slot configurations are contemplated within the scope of the present invention.

The letter cards 22 may be formed in various colors, typically as clear plastic, with colored lettering on each card 22. The letter cards 22 may have a height designed to fit and be retained by the slots 20 of the upper and lower boarders 14, 16. The letter cards 22 may be slid into the slots 20 from one end of the sign 10. In some embodiments, the letter cards 22 may be flexible enough to permit a user to bend and insert the card 22 in a mid-section of the sign, into the slots 20. The letter cards 22 may be weatherproof letter cards. For example, the letter cards 22 may be made to be weatherproof by being made from an impermeable material, such as plastic. The actual data (such as the letters H, W, K as shown in FIG. 1) may be pre-printed on the letter cards 22 or the letters may be provided as peel and stick letters that can attach to blank letter cards.

Referring to FIG. 3, in some embodiments, a central boarder 18 may be provided having an upper slot 24 opening on a top side of the central boarder 18 and a lower slot 26 opening on a bottom side thereof. The central boarder 18 may be used where two lines of interchangeable text are desired on the sign 10. In some embodiments, a user may simply use one upper boarder 14 and one lower boarder 16 in place of the central boarder 18, to provide a two-lined sign.

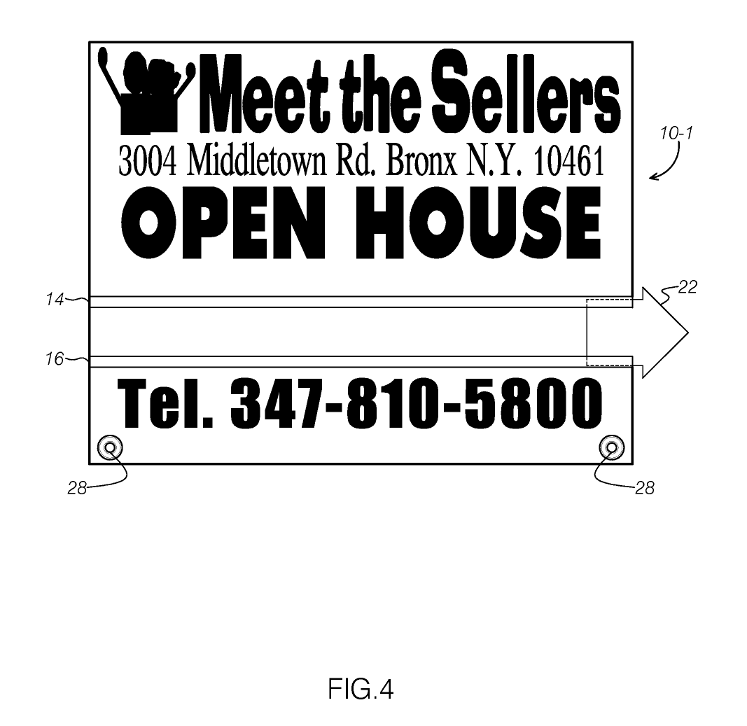

Referring to FIGS. 4 and 5, in some embodiments, a sign 10-1 can include an attachment member, such as holes 28 on bottom corners of the sign 10-1. The holes 28 can be secured by grommets for strength. The sign 10-1 may or may not include a place to hold letter cards 22, as described above. The holes 28 may interact with attachment members 30 on a sign attachment 32 such that the sign attachment 32 can be hung on the holes 28 in the sign 10-1. The sign attachment can include upper and lower boarders 34, 36 to hold letter cards 22, as described above. The sign attachment 32 can be formed in various shapes, such as an arrow, as shown in FIG. 5.

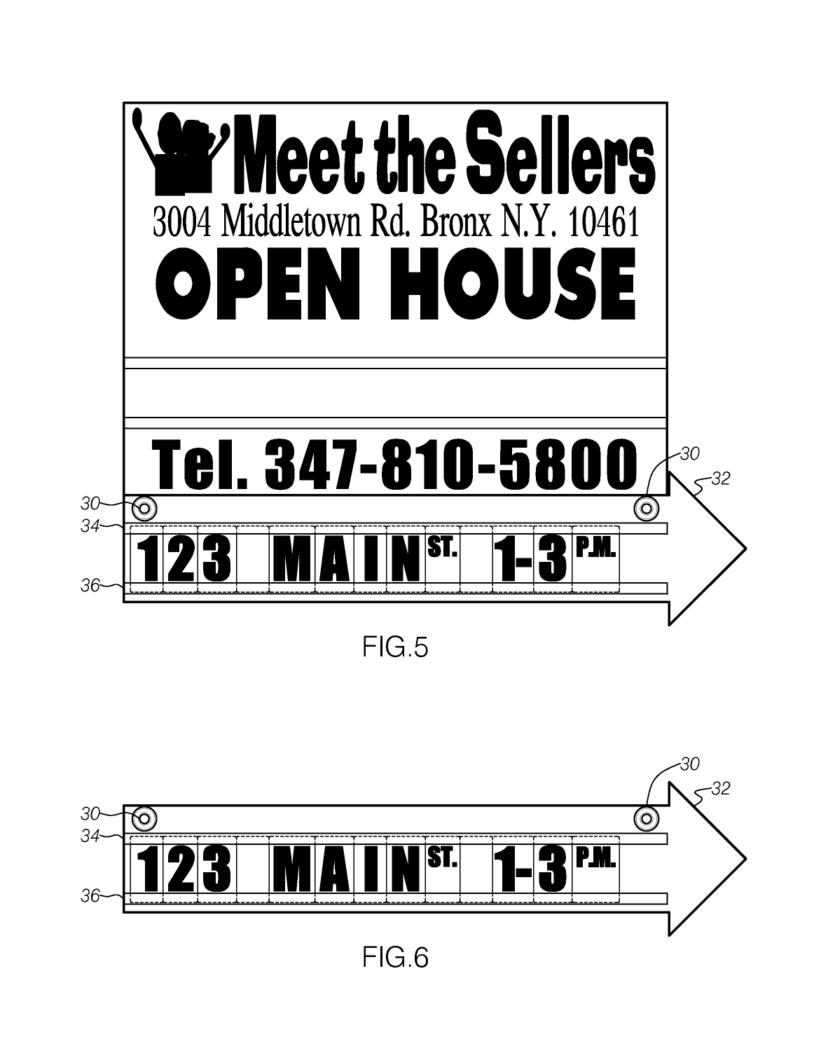

In some embodiments of the present invention, the sign attachment 32 can be formed and used as a separate piece, as shown in FIG. 6. Hooks (not shown), or the like, can be disposed in a conventional sign, on a wall, or the like, to secure the sign attachment 32.

The open house sign of the present invention can provide, by simply sliding plastic letters in or out, a professionally looking sign that can withstand various weather conditions.

While the above description has focused on open house signs, the signage of the present invention could be used in other circumstances where directing a person toward a specific location is desired. For example, the signage of the present invention could be useful for people having garage sales, for general advertisements, and the like.

It should be understood, of course, that the foregoing relates to exemplary embodiments of the invention and that modifications may be made without departing from the spirit and scope of the invention as set forth in the following claims.

1. An open house sign comprising:
at least two boarders attached, parallel to each other, to a front face of the open house sign;
preprinted information on the front face of the open house sign, where the at least two boarders define a region therebetween without preprinted information on the front face;
a slot in each of the boarders, the boarders disposed with an open end of the slots facing each other; and
a plurality of letter cards adapted to be inserted into and retained by the slots of adjacent ones of the boarders.

2. (canceled)

3. The open house sign of claim 1, wherein the plurality of letter cards are clear plastic cards having data printed thereupon.

4. The open house sign of claim 1, wherein the letter cards are formed from a weatherproof material.

5. The open house sign of claim 1, further comprising at least a third boarder, disposed parallel to and in between the first and second boarders, the third boarder having an upper slot opening toward one of the at least two boarders, and the third boarder having a lower slot opening toward another one of the at least two boarders.

6. The open house sign of claim 1, wherein the letter cards have a number, a letter, a symbol, or a directional arrow printed thereupon.

7. An open house sign comprising:
preprinted information on a front face of the open house sign, the preprinted information including Realtor contact information;
at least two boarders attached, parallel to each other, to the front face of the open house sign, the two boarders forming a region therebetween without the preprinted information;
a slot in each of the boarders, the boarders disposed with an open end of the slots facing each other;
a plurality of weatherproof letter cards adapted to be inserted into and retained by the slots of adjacent ones of the boarders; and
a directional indicator viewable from the front face of the open house sign.

8. The open house sign of claim 7, wherein the plurality of weatherproof letter cards are clear plastic cards having data printed thereupon.

9. The open house sign of claim 7, further comprising at least a third boarder, disposed parallel to and in between the first and second boarders, the third boarder having an upper slot opening toward one of the at least two boarders, and the third boarder having a lower slot opening toward another one of the at least two boarders.
